(19) United States
(12) Patent Application Publication
(10) Pub. No.: US 2011/0150354 A1
(43) Pub. Date: Jun. 23, 2011

(54) IMAGE UP-SAMPLING METHOD USING 2D WAVELET FILTERS

(75) Inventor: Xiaodong Huang, Nepean (CA)

(73) Assignee: MAGOR COMMUNICATIONS CORPORATION, Ottawa (CA)

(21) Appl. No.: 12/642,037

(22) Filed: Dec. 18, 2009

(51) Int. Cl. G06K 9/40; G06K 9/32; H04N 7/14

(52) U.S. Cl. 382/260; 382/300; 348/14.08

(57) ABSTRACT

An original image is up-sampled to a final image by constructing at least two sub-banded filtered images of the original image with 2D wavelet-based decomposition filters, each filtered image being of the same resolution as the original image. Each sub-banded filtered image is then mapped into a larger filtered image of the same size as the final image. Pixels in each larger filtered image which were not mapped in from the sub-banded filtered images are interpolated or left blank. The larger filtered images are then filtered with 2D reconstruction filters and combined to form the final up-sampled image. The invention has the advantage that high quality up-sampled images can be created in real time suitable for high definition video.

### FIELD OF THE INVENTION

This invention relates to the field of image processing, and more particularly to a method of up-sampling images, and in particular video images. The method is suitable for converting standard video to high definition video especially in real time applications such as video conferencing.

### BACKGROUND OF THE INVENTION

In image processing, up-sampling is used to magnify an entire image or to zoom into a part of an image. Up-sampling involves using some technique to fill in empty pixels when an image of a given resolution is displayed at a higher resolution. When the image is a video frame, the up-sampling must be performed in real-time. The term “real-time” typically means being capable of up-sampling an image with resolution of 960×540 to 1920×1080 (full high definition), with frame rate of 30 fr/sec.

Currently, the most commonly used up-sampling methods are nearest neighbor, bilinear interpolation, and bicubic interpolation (applied directly to the original image). Among these three methods, the nearest neighbor gives the coarsest visual quality with grid effects along edges (especially along diagonal edges). Bilinear and bicubic interpolations give images with more natural edges, but with blurred visual quality.

Another more advanced up-sampling method utilizes the Lanczos filter. See, for example, Claude E. Duchon (August 1979). “Lanczos Filtering in One and Two Dimensions”. Journal of Applied Meteorology 18 (8): pp. 1016-1022. Usually, at the level of up-sample-by-2, the visual quality of the up-sampled image using Lanczos filter is better than that of bilinear and bicubic interpolation, but is still noticeably blurred compared to the original image.

There are even more advanced and complex algorithms for image up-sampling, e.g., the level set-based algorithm, which iteratively controls the contour evolution in the up-sampling process. However, such methods usually require a very long time to up-sample an image (for given computing power), and therefore are not suitable for real-time applications.

There is an up-sample-by-2 method, which is based on one-dimensional (1D) wavelet filter bank, which is suitable for real-time applications under current hardware/software conditions. The method is described in paper: Image Up-Sampling Using Discrete Wavelet Transform, Ping-Sing Tsai and Tinku Acharya, Proceedings of Joint Conference on Imformation Sciences, 2006. It is also described in U.S. Pat. No. 6,377,280.

This method is briefly described with reference to FIG. 1 and in a way that parallels the description of the present invention. As shown in FIG. 1, an original image I with resolution W×H is put through a wavelet decomposition process, in which a low-pass filter L1 and a high-pass filter H1 are applied to each ROW of the image followed by down-sample-by-2 in each ROW. Then, with two intermediate images from above operations, the low-pass filter L1 and the high-pass filter H1 are applied to each COLUMN of the two intermediate images respectively, followed by down-sample-by-2 in each COLUMN. Thus, after these filtering and down-sampling operations in ROW and COLUMN directions, there are four sub-band images LL (low-pass—low-pass), LH (low-pass—high-pass), HL (high-pass—low-pass), and HH (high-pass—high-pass), each with resolution

$$\frac{1}{2} W \times \frac{1}{2} H .$$

Up until now, these operations are the same as in a standard 1D wavelet filter bank decomposition (known at the time of the invention). Tsai and Acharya modified the structure of the four sub-bands for the purpose of up-sampling by 2. For the two sub-bands LH, HL, they increase their resolution by 2, i.e. from

$$\frac{1}{2} W \times \frac{1}{2} H W \times H ,$$

and put each pixel in the original sub-bands to the upper-left pixel location of the corresponding 2×2 pixel group in the up-sampled sub-bands. For sub-band LL, Tsai and Acharya discard the LL from the decomposition filter and replace it with the original image after applying a scaling factor to it, and therefore the resolution of LL also increased from

$$\frac{1}{2} W \times \frac{1}{2} H W \times H .$$

For sub-band HH, Tsai and Acharya just replaced it using an all zero image with resolution W×H.

Now, the four modified sub-bands (LL2, LH2, HL2 and HH2) with resolution W×H are put through a standard reconstruction process using wavelet filter bank, as shown in FIG. 1, in which each sub-band is up-sampled-by-2 for each COLUMN. Then, the up-sampled LL2 and LH2 (HL2 and HH2) are filtered with a low-pass filter L2 and a high-pass filter H2 respectively, for each COLUMN, and the filtering results are summed together, resulting in two intermediate images with resolution W×2H. These two intermediate images are up-sampled-by-2 for each ROW, and put through the low-pass filter L2 and the high-pass filter H2 respectively, and summed together as the final up-sampled image Iₓ₂ with resolution 2W×2H.

While this method is capable of working in real-time, there are noticeable artifacts along edges.

Another wavelet-based up-sampling method is described in the paper Edge-preservation resolution enhancement with oriented wavelets, V. Velisavljevic, Proceedings of IEEE Int. Conf. on Image Proc. (ICIP), 2008. This method applies a 1D wavelet filter to five directions in the image, and estimates a directional map by comparing the filtering results on five directions for each pixel. The up-sampling process is based on this estimated directional map. The algorithm works well in preserving the original shape of the edges, but at the expense of higher complexity. It is therefore not suitable for real-time applications of HD video under current hardware/software conditions.

### SUMMARY OF THE INVENTION

An object of the invention is to up-sample an image in real-time with very good visual quality so that the invention can be used for up-sampling a standard definition video to high definition video. The term “very good visual quality” means the up-sampled image should have a degree of crispness similar to the original image without adding obvious artifacts.

According to the present invention there is provided a method of up-sampling an original image to a final up-sampled image, comprising: constructing at least two sub-banded filtered images of the original image with 2D wavelet-based decomposition filters, each filter image being of the same resolution as the original image; mapping each of the sub-banded filtered images into a larger filtered image of the same size as the final image, wherein pixels in each larger filtered image that were not mapped in from the sub-banded filtered images are interpolated or left blank; filtering the larger filtered images with 2D reconstruction filters; and combining the outputs of the 2D reconstruction filters to form the final up-sampled image.

In one embodiment the invention provides a method of up-sampling, i.e. zooming in, a digital image by first building at least two filtered images of the original image using decomposition filters. Each of the filtered images, which are the same size as the original, is then mapped into a larger filtered image. The larger filtered images are each equal in size to the final image size. Pixels in each larger filtered image which were not mapped in are interpolated from mapped pixels or left blank. Finally the larger filtered images are filtered again using reconstruction filters and combined to form the up-sampled image. All filters are different and are based on the theory of perfect reconstruction wavelet filter banks. In one embodiment quincunx filters are used.

The invention is wavelet-based. Unlike prior art wavelet-based up-sampling methods in which 1D wavelet filters are used with at least four sub-bands involved, the invention uses non-separable 2D wavelet filters (quincunx filter bank) and in one embodiment only has two sub-bands involved.

Unlike the method of Tsai and Acharya, embodiments of the invention do not discard sub-band pixel values in the wavelet decomposition stage. One diagonal pixel is interpolated for the two sub-bands before reconstruction. For the up-sampling of the low-pass filtered sub-band, the invention does not require the use any scaled pixel values of the original image.

Unlike the above two wavelet-based up-sampling methods in which the same wavelet reconstruction filters are used compared to the standard wavelet filter bank, embodiments of the invention adjust the reconstruction wavelet filters in order to bring more crisp up-sampled images.

In another aspect the invention provides an apparatus for up-sampling an original image to a final up-sampled image, comprising: a plurality of 2D wavelet-based decomposition filters for constructing at least two sub-banded filtered images of the original image with, each filter image being of the same resolution as the original image; up-sampling units for mapping each of the sub-banded filtered images into a larger filtered image of the same size as the final image, wherein pixels in each larger filtered image that were not mapped in from the sub-banded filtered images are interpolated or left blank; 2D reconstruction filters for processing the larger filtered images; and a combiner to form the final up-sampled image from the filtered images output by the 2D reconstruction filters.

### BRIEF DESCRIPTION OF THE DRAWINGS

The invention will now be described in more detail, by way of example only, with reference to the accompanying drawings, in which:—

FIG. 1 is a block diagram of a prior art up-sampling system;

FIG. 2 is a block diagram of an up-sampling system in accordance with an embodiment of the invention;

FIG. 3 is a block diagram of a video display system;

FIGS. 4a to 4d show the filter coefficients for various filters;

FIGS. 5a and 5b shows the filtered image and the up-sampled filter image respectively; and

FIGS. 6a and 6b show the reconstruction filter coefficients; and

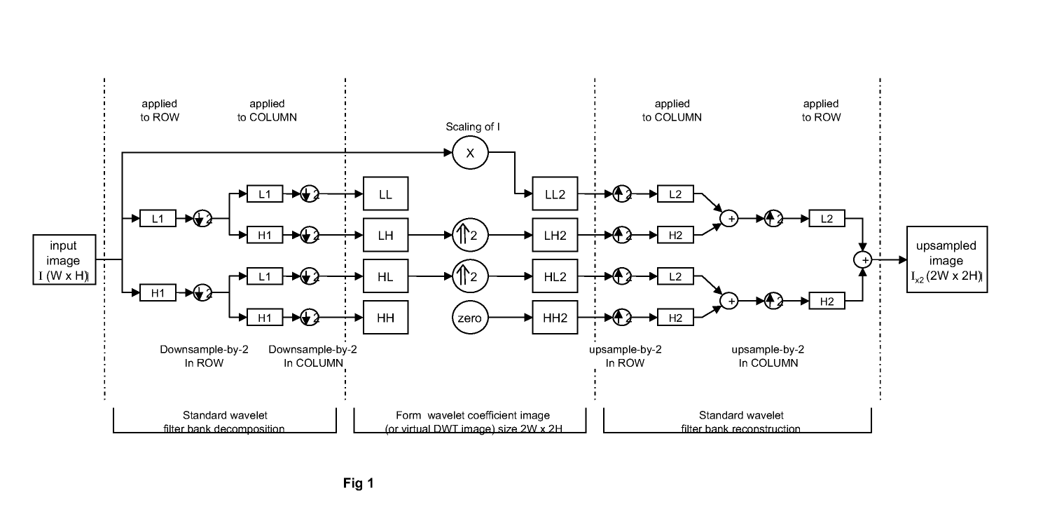

### DETAILED DESCRIPTION OF THE INVENTION

One embodiment of the invention will now be described. A typical video display system is illustrated in FIG. 3. Video endpoint 304 comprises a processor 306, memory 314 and display subsystem 308. Video Source 302, typically a distant video endpoint, transmits video signal 320 via network interface 312 to endpoint 302 where each video frame is temporarily stored in memory 314. The frame is subsequently retrieved from memory 314 and displayed by display system 308, after which it is discarded. In applying the invention each received frame is first processed to produce a larger image, e.g. twice the size, before it is displayed.

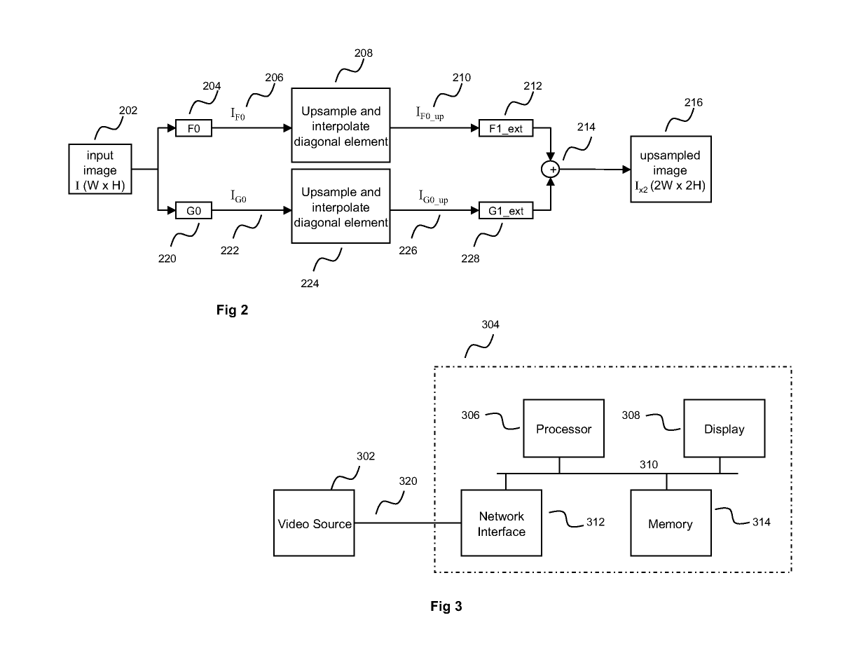

The basic structure of the invention is shown in FIG. 2. The input image I 202 with resolution W×H is filtered by low-pass 2D filter F0 204 and high-pass 2D filter G0 220, resulting in intermediate images I_{F0} 206 and I_{G0} 222, both with resolution W×H, the same as the input image 202.

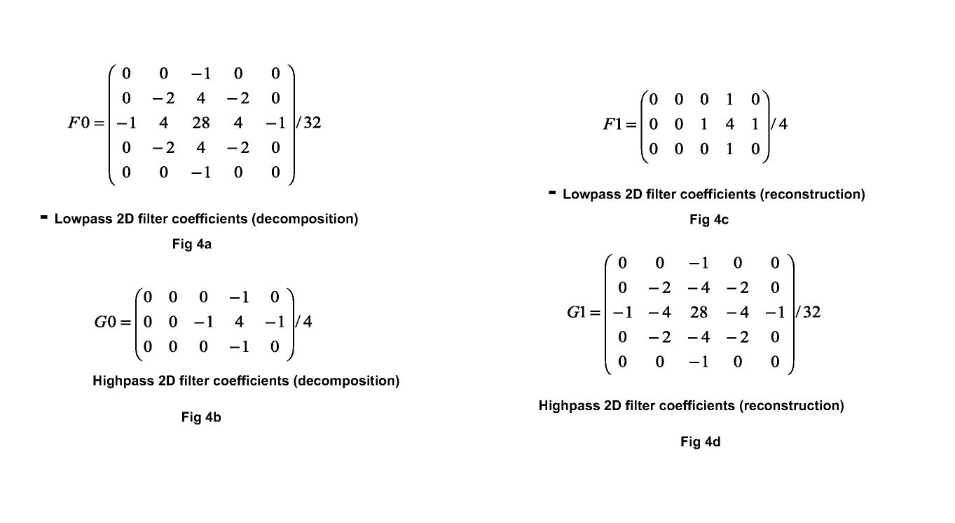

Both filters 204 and 220 are non-separable 2D wavelet quincunx filters. The theory behind the quincunx filter is described in “Perfect reconstruction filter banks for HDTV representation and coding” by M. Vetterli, J. Kova\check{c}ević and D. J. LeGall published in Image Comm. Journal, special issue on HDTV, vol. 2, no. 3, October 1990, pp. 349-364, the contents of which are herein incorporated by reference. The coefficients used in filter 204 are shown in FIG. 4a, and for filter 220 are shown in FIG. 4b. FIGS. 4c and 4d show corresponding reconstruction filter masks as described in the paper. These reconstruction filter masks are modified for use in the invention as will be described later.

Returning to FIG. 2, without down-sampling or discarding any pixels, the two sub-bands I_{F0} 206 and I_{G0} 222 are each put through a 2D up-sampling and interpolation process.

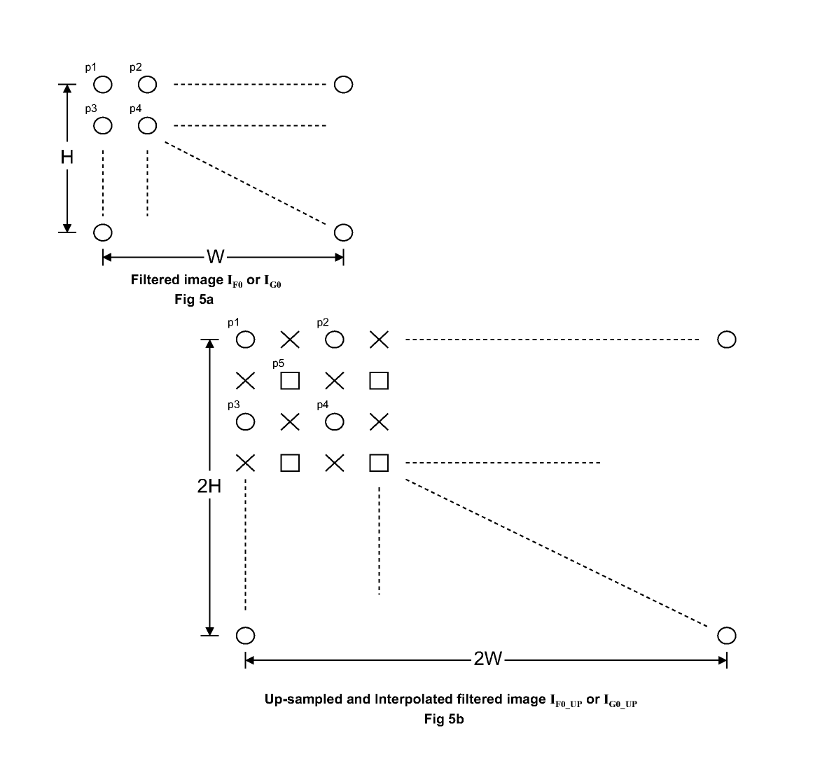

The up-sampling and interpolation process is described with reference to FIG. 5, where FIG. 5a illustrates a filtered image, either 206 or 204, W pixels wide and H pixels high. FIG. 5b illustrates the corresponding up-sampled interpolated image, either 210 or 226 respectively. It is twice the size, i.e. 2W pixels wide and 2H pixels high. The interpolation process determines the value of pixels on the diagonal not mapped from the filtered image.

By way of example, FIG. 5a shows any 2×2 group of pixels in I_{F0} (or I_{G0}), with labels and coordinates as p1(x,y), p2(x+1,y), p3(x,y+1), p4(x+1,y+1). In the up-sampled images I_{F0}_{_{—}}ᵤₚ and I_{G0}_{_{—}}ᵤₚ, p1, p2, p3 and p4 are mapped into coordinates at (2*x−1, 2*y−1), (2*x+1, 2*y−1), (2*x−1, 2*y+1) and (2*x+1, 2*y+1) respectively. That is to say the value of p1 in FIG. 5b is the same as the value of p1 in FIG. 5a. Then, for the diagonal pixel p5 at coordinates (2*x, 2*y), we interpolate it based on the values of p1, p2, p3 and p4 using the following method:

calculate dif1=|p1−p4|, and dif2=|p2−p3|

if (dif 1>dif 2)

then

$$p 5 = \frac{p 2 + p 3}{2}$$

else if (dif 1<dif 2)

then

$$p 5 = \frac{p 1 + p 4}{2}$$

else

$$p 5 = \frac{p 1 + p 2 + p 3 + p 4}{4}$$

The above up-sampling and interpolation procedure is iteratively applied to each pixel on the diagonal. The remaining pixels in the rows and columns containing the directly mapped pixels from the filtered image remain zero in value in the preferred embodiment of the invention. We now have two adjusted sub-bands I_{F0}_{_{—}}ᵤₚ 210 and I_{G0}_{_{—}}ᵤₚ 226 each with resolution 2W×2H.

This process is referred to as up-sampling and interpolate diagonal element, and is illustrated in FIG. 2 by blocks 208 and 224.

In the final stage each adjusted sub-band 210 and 226 is processed through reconstruction filters 212 and 228 respectively and then additively mixed in adder 214 (i.e. the value of each pixel p₂₁₂(x,y) resulting from 212 is added to the value of the corresponding pixel p₂₂₈(x,y) resulting from 228 to yield the corresponding pixel p(x,y) in the up-sampled image 216.

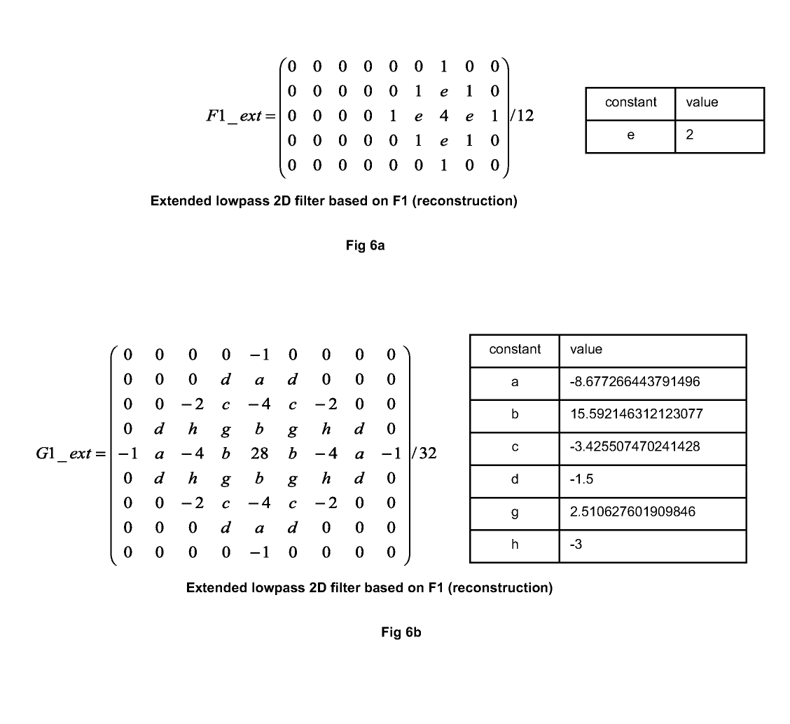

The reconstruction filter masks used in the embodiment of the invention are extended versions of the 2D reconstruction filter masks illustrated in FIGS. 4c and 4d. The extended filter masks are illustrated in FIG. 6. The mask shown in FIG. 6a is used in filter F1_ext 212 and the mask shown in FIG. 6b is used in filter G1_ext 228. Certain values are shown in the accompanying table in FIG. 6b for clarity.

The need for extended filter masks and how they are created follows.

Filter masks F1_ext and G1_ext are up-sample-by-2 and interpolated versions of F1 and G1 respectively (note that the up-sample and interpolation method used to create F1_ext and G1_ext are different from what we described above for the up-sample of the image itself).

The theory of perfect reconstruction teaches how to precisely reproduce an image of the same size (i.e. same number of pixels) as the original after first down-sampling into sub-bands and then subsequently up-sampling and merging the sub-bands. Since it is an object of the invention to produce an image of larger size (i.e. more pixels) than the original, this underlying theory must be adapted. This embodiment does not down-sample nor does it discard any pixels from the two sub-bands I_{F0} and I_{G0}. Therefore, in the reconstruction stage, in order to keep the correspondences between the sub-band pixels and filter coefficients as in the original reconstruction filter bank (not for up-sampling purposes), the 2D reconstruction filters F1 and G1 are extended, and the empty filter coefficient locations are filled using bicubic spline interpolation.

Based on lab tests and subjective opinions bicubic spline interpolation increases the degree of crispness of the resulting up-sampled-by-2 images. The values of a, b, c, d, e, g, h etc. are not restricted to the values shown in FIG. 6 but reflect the best embodiment of the invention known at this time. Other values could be used if better results can be obtained particularly if up-sampling by ratio other than two.

The invention might be further developed for higher up-sampling ratio, by changing the structure of the filter bank, e.g., adding more filters which are based on M-channel wavelet filter bank.

It should be appreciated by those skilled in the art that any block diagrams herein represent conceptual views of illustrative circuitry embodying the principles of the invention. For example, a processor may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), and non volatile storage. Other hardware, conventional and/or custom, may also be included.

I claim:

1. A method of up-sampling an original image to a final up-sampled image, comprising:
constructing at least two sub-banded filtered images of the original image with 2D wavelet-based decomposition filters, each filter image being of the same resolution as the original image;
mapping each of the sub-banded filtered images into a larger filtered image of the same size as the final image, wherein pixels in each larger filtered image that were not mapped in from the sub-banded filtered images are interpolated or left blank;
filtering the larger filtered images with 2D reconstruction filters; and
combining the outputs of the 2D reconstruction filters to form the final up-sampled image.

2. A method as claimed in claim 1, wherein said wavelet decomposition filters comprise a low-pass 2D filter and a high-pass 2D filter.

3. A method as claimed in claim 2, wherein said wavelet decomposition filters are quincunx filters.

4. A method as claimed in claim 1, wherein in the sub-banded filtered image, the pixels are grouped in two-dimensional sub-arrays, and the pixels on the diagonals in the sub-arrays in the larger filtered images not mapped from the sub-banded filtered images are interpolated.

5. A method as claimed in claim 4, wherein each sub-array contains a 2×2 group of pixels.

6. A method as claimed in claim 5, when the pixels of each group in the sub-banded filtered images have the coordinates p1(x,y), p2(x+1,y), p3(x,y+1), p4(x+1,y+1), and in the larger images p1, p2, p3 and p4 are mapped into coordinates at (2*x−1, 2*y−1), (2*x+1, 2*y−1), (2*x−1, 2*y+1) and (2*x+1, 2*y+1) respectively, and the diagonal pixel p5 at coordinates (2*x, 2*y) in the larger image is interpolated based on the values of p1, p2, p3 and p4 using the following procedure:
calculate dif1=|p1−p4|, and dif2=|p2−p3|

if (dif 1>dif 2)
then
$$p 5 = \frac{p 2 + p 3}{2}$$
else if (dif 1<dif 2)
then
$$p 5 = \frac{p 1 + p 4}{2}$$
else
$$p 5 = \frac{p 1 + p 2 + p 3 + p 4}{4}$$

7. A method as claimed in claim 6, wherein the procedure is applied iteratively to each pixel on the diagonal in the group.

8. A method as claimed as claimed in claim 7, wherein the larger filtered images are additively combined after passing through reconstruction filters to form the final up-sampled image.

9. A method as claimed in claim 1, wherein empty filter coefficient locations in the reconstruction filters are filled by interpolation.

10. A method as claimed in claim 9, wherein said empty filter locations are filled using bicubic spline interpolation.

11. An apparatus for up-sampling an original image to a final up-sampled image, comprising:
a plurality of 2D wavelet-based decomposition filters for constructing at least two sub-banded filtered images of the original image with, each filter image being of the same resolution as the original image;
up-sampling units for mapping each of the sub-banded filtered images into a larger filtered image of the same size as the final image, wherein pixels in each larger filtered image that were not mapped in from the sub-banded filtered images are interpolated or left blank;
2D reconstruction filters for processing the larger filtered images; and
a combiner to form the final up-sampled image from the filtered images output by the 2D reconstruction filters.

12. An apparatus as claimed in claim 11, wherein said wavelet decomposition filters comprise a low-pass 2D filter and a high-pass 2D filter.

13. An apparatus as claimed in claim 12, wherein said wavelet decomposition filters are quincunx filters.

14. An apparatus as claimed in claim 1, wherein the up-sampling units group the pixels in the sub-banded filtered image in two-dimensional sub-arrays, and interpolate the pixels on the diagonals in the sub-arrays in the larger filtered images that are not mapped from the sub-banded filtered images.

15. An apparatus as claimed in claim 14, wherein each sub-array contains a 2×2 group of pixels.

16. An apparatus as claimed in claim 15, when the pixels of each group in the sub-banded filtered images have the coordinates p1(x,y), p2(x+1,y), p3(x,y+1), p4(x+1,y+1), and in the larger images p1, p2, p3 and p4 are mapped into coordinates at (2*x−1, 2*y−1), (2*x+1, 2*y−1), (2*x−1, 2*y+1) and (2*x+1, 2*y+1) respectively, and the diagonal pixel p5 at coordinates (2*x, 2*y) in the larger image is interpolated based on the values of p1, p2, p3 and p4 using the following procedure:
calculate dif1=|p1−p4|, and dif2=|p2−p3|

if (dif 1>dif 2)
then
$$p 5 = \frac{p 2 + p 3}{2}$$
else if (dif 1<dif 2)
then
$$p 5 = \frac{p 1 + p 4}{2}$$
else
$$p 5 = \frac{p 1 + p 2 + p 3 + p 4}{4}$$

17. An apparatus as claimed in claim 16, which is configured to apply the procedure iteratively to each pixel on the diagonal in the group.

18. An apparatus as claimed as claimed in claim 17, wherein said combiner is an adding for adding the outputs of the reconstruction filters to form the final up-sampled image.

19. An apparatus as claimed in claim 18, which is configured such that empty filter coefficient locations in the reconstruction filters are filled by interpolation.

20. An apparatus as claimed in claim 9, which is configured such that said empty filter locations are filled using bicubic spline interpolation.
